(19) United States
(12) Patent Application Publication
(10) Pub. No.: US 2013/0236285 A1
(43) Pub. Date: Sep. 12, 2013

(54) Apparatus for Handling Layers of Goods

(71) Applicant: THE PROCTER & GAMBLE COMPANY, Cincinnati, OH (US)

(72) Inventors: Karel M. M. Maurissen, Strombeek-Bever (BE); Michael K. Nubel, Glatten (DE); Herman F. M. Tesseur, Aartselaar (BE)

(73) Assignee: The Procter & Gamble Company, Cincinnati, OH (US)

(21) Appl. No.: 13/733,298

(22) Filed: Jan. 3, 2013

(30) Foreign Application Priority Data
Mar. 7, 2012 (EP) 12158484.1

(51) Int. Cl. B66F 9/18

(52) U.S. Cl. CPC B66F 9/181
USPC 414/800; 294/183; 294/188; 294/185

(57) ABSTRACT

Apparatus, for mounting on a forklift truck, for handling layers of goods; in particular for moving layers of goods from and onto pallets. The apparatus comprises a suction box, connectable to a vacuum source, and a fixture for mounting the apparatus to a forklift truck. The suction box comprises a suction surface for placement against an upper surface of the layer of goods and a skirt having a generally rectangular horizontal section and four vertically disposed, laterally displaceable faces, for movement against the sides of the layer of goods. The apparatus further comprises one or more clamps for positioning the skirt against the layer and at least one valve for controlling the application of the vacuum to the layer.

The invention further relates to a method of using the apparatus, for lifting a layer of packaged goods.

### FIELD OF THE INVENTION

The present invention concerns an apparatus, which is mountable on a forklift truck, for handling layers of goods, in particular for removing a layer of goods from a pallet or depositing a layer onto a pallet, by generating and maintaining sufficient vacuum pressure on the layer that the layer can be lifted by the apparatus.

### BACKGROUND OF THE INVENTION

Many packaged consumer goods, such as foods, detergents, personal care products and the like, are distributed on pallets which typically comprise multiple layers of such products. A single, loaded, pallet may comprise only one type of good, optionally bundled into groups or trays, or may comprise several different types of good—so-called mixed pallets. The pallet provides an efficient means of distribution and much infrastructure has been built up around them. Forklift trucks, for example, are designed for moving whole pallets of goods. Large customers for such palletised goods may have no difficulty in dealing with whole pallets of one type of good. There is also a need though for dispatching orders comprising smaller consignments of goods. Smaller customers may wish to take only one or a small number of layers from a pallet or to transport individual layers to different parts of a warehouse for example. In such cases there is a need for removing single layers of goods from the top of a pallet.

WO 2000/64790 A1, WO 2008/019691 A1 and WO 2010/097088 A1 disclose apparatuses for handling layers of palletised goods. The apparatuses comprise a vertically displaceable lift head with a horizontal suction face adapted in size to a pallet and comprising a large number of open suction chambers. The suction face is arranged to be moved downwards against the top side of an upper layer of packaged goods on a pallet. The suction chambers are connected with a source of vacuum incorporated in the lift head and operated via individual valves which allow control of the vacuum. When the vacuum is applied and the lift head is raised the layer of goods is lifted from the pallet. The layer can then be moved to a different location and deposited by releasing the vacuum. This method of lifting or ‘picking’ a layer avoids crushing the goods by squeezing the layer at its sides but depends, for its operation, on the maintenance of an efficient vacuum above the goods. The vacuum blowers used for generating such vacuums can be costly to run and very heavy. Leakage of air around the sides of the goods or through gaps between the goods challenges the maintenance of the vacuum and therefore the efficiency of the layer picking process.

The apparatus can be an accessory to a forklift truck, as described in U.S. Pat. No. 7,665,949 B2 or it can be part of a custom designed robot, as set out in WO 2010/097088 A1. The accessory for a forklift truck approach has the attraction of using existing infrastructure and allowing a picked layer to be easily moved to a location remote from the pallet. For reasons of weight and power supply though, it places great demands on the efficiency of the lifting process. Further, the precise positioning of the lift head, in relation to the layer of goods as it is to be picked, and the control of the vacuum adds to the demands placed on the forklift truck driver who may have restricted visibility of the layer and/or other demands upon his attention.

The present invention provides an apparatus, a vacuum layer picker, which can be mounted to a forklift truck, which can efficiently seal around a layer of goods, thereby enabling a lower weight apparatus and lower demand on the power supply of the forklift truck. The apparatus further comprises features to assist an operator of the forklift truck in positioning the apparatus against the layer of goods without undue manoeuvring.

### SUMMARY OF THE INVENTION

A first aspect of the invention provides an apparatus, for mounting on a forklift truck, for handling layers of goods; in particular for removing a layer of goods from a pallet and depositing it elsewhere or taking a layer from elsewhere and depositing it onto a pallet. The apparatus comprises a suction box, connectable to a vacuum source, and a fixture for mounting the apparatus to a forklift truck. The suction box comprises a suction surface for placement against an upper surface of the layer of goods and a skirt having a generally rectangular horizontal section and four vertically disposed, laterally displaceable faces, for movement against the sides of the layer of goods. The apparatus further comprises one or more clamps for positioning the skirt against the layer and at least one valve for controlling the application of the vacuum to the layer.

The invention further relates to a method of using the apparatus, when fixed to a forklift truck, to lift a layer of packaged goods.

A further aspect of the invention relates to the use of a PID loop for regulating the vacuum pressure of a vacuum lifting apparatus, especially one mounted on a forklift truck.

### BRIEF DESCRIPTION OF THE DRAWINGS

The invention is explained in more detail in the following with reference to the drawings, in which:

FIG. 1 shows a schematic cross-section of a forklift truck fitted with the layer-handling apparatus according to the invention.

FIG. 2 shows a perspective view of a suction box with its associated skirts.

FIG. 3 shows a perspective view of the apparatus according to the invention, as seen from the front side, that is, the side opposite the fixture for fixing the apparatus to the forklift truck mast. Some of the parts, notably vacuum ducting connecting the suction box to the vacuum blower, are omitted in this drawing.

FIGS. 4A, 4B and 4C are schematic front views of the apparatus according to the invention, showing its operation in picking up and depositing a layer of goods.

FIGS. 5A and 5B show partial, schematic plan views of a clamp showing its approach to a layer of goods, including the situation where the approach is slightly oblique, inducing the clamp to pivot relative to a supporting clamp holder. For simplicity, the suction box skirt, which would be between the clamping bar and the layer, is not shown in these figures.

### DETAILED DESCRIPTION OF THE INVENTION

As used herein, the terms ‘horizontal’, ‘horizontally’, ‘vertical’, ‘vertically’, ‘up’, ‘upper’, ‘down’, ‘lower’ and the like will have their commonly understood meanings unless otherwise specified. As is conventional, coordinates x and y refer to mutually perpendicular directions in the horizontal plane and z refers to a vertical direction.

The term ‘vacuum’ as used herein does not of course refer to absolute vacuum but to a lower pressure than the prevailing atmospheric pressure and references to vacuum pressure refer to this pressure differential.

The invention concerns an apparatus, for mounting on a forklift truck, for handling layers of palletised goods. The goods, such as cans, cartons tissue rolls and the like, will typically be packaged in cases having a rectangular footprint. The cases may be cardboard cartons or shrink-wrapped bundles which may be reinforced at the base by a cardboard tray. A layer of goods may comprise several identical cases or a mix of cases of different types. Though cases of goods within a layer may closely abut each other it will usually be the case that some air will be able to pass through gaps between the cases. A pallet of goods may comprise several layers and a liner, of card for example, may be used to separate one layer from another layer above or below it.

The fork lift truck for which the apparatus is intended will usually be of the known type comprising a lift mast disposed in front of a driver's cab to which a pair of forks would normally be attached for insertion into a pallet so that the pallet can be raised or lowered by means of a powered lift mechanism forming part of the mast. The layer-handling apparatus of the invention will typically be fixed to the mast, in place of the forks, by means of a bolted bracket or the like.

The apparatus comprises a suction box, for placing over a layer of goods, and lifting it through the application of a vacuum source which will generally be a vacuum blower of known type. In the embodiment described herein the vacuum blower is mounted on top of the apparatus but the blower could also be mounted on the fork lift truck itself and linked to the suction box by appropriate ducting. It is preferred that the vacuum blower is mounted on top of the apparatus to minimize the size of ducting runs and associated vacuum chambers. The vacuum blower and any other electrical apparatus needing to support a high electrical load, such as electrical motors for moving discrete parts of the apparatus, will generally be powered from the main power supply of the forklift truck. Low load electrical equipment such as sensors and cameras could in principle have their own electrical supply, such as a dedicated battery.

The layer-handling apparatus of the invention will now be described in more detail by reference to a preferred embodiment.

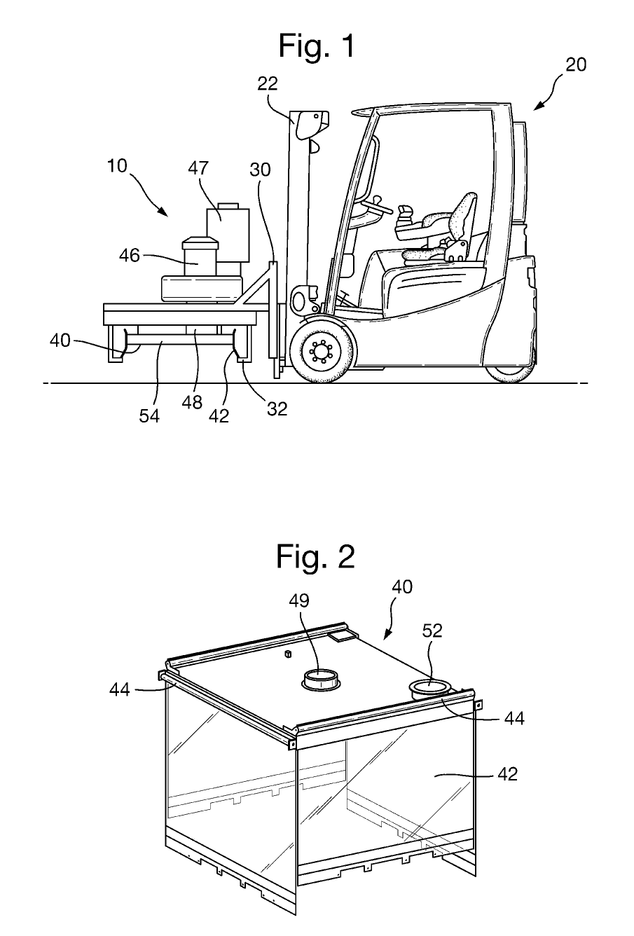

FIG. 1 shows a schematic cross-section of a forklift truck 20 fitted with the layer-handling apparatus 10 according to the invention. The apparatus has a support frame 30 which is bolted to the mast 22 of the forklift truck. Mounted within the cabin of the truck is a control panel for the apparatus, including switches and alarms for example. A video display is also mounted within the cabin to allow a driver of the truck better to view output from cameras mounted on the apparatus to assist the driver in positioning the suction box over a layer or to position a layer carried by the apparatus on top of a pallet or other surface.

The apparatus comprises suction box 40 which is generally rectangular in plan view and will typically be dimensioned to be slightly larger in plan section than the typical plan dimensions of a standard pallet. The suction box is suspended from the support frame by balancing cables and a belt and can translate vertically relative to the frame. Depending from suction box 40, and best seen in FIG. 2, is its associated skirt 42 which is rectangular in plan section and segmented into four faces. The faces are independently moveable and retractable onto rollers 44 which can be motor driven or sprung so that the skirt retracts into the roller when no tension is applied to it. The skirt is made of an air impervious, fiber-reinforced plastic or rubber material that is sufficiently flexible to conform to the sides of a layer of goods when pressed against it whilst being sufficiently thick to be resistant to wear and tear. At its lower edges the skirt is attached to clamping bars 32. When fully extended the skirt should ideally be of sufficient depth to cover substantially all of the sides of the layer to prevent air ingression through its sides during the lifting operation and making it more difficult to maintain sufficient vacuum to lift the layer. Though some vacuum losses can be tolerated, any losses mean the vacuum blower has to work harder with a consequent greater drain on the truck power supply. Mounted on top of the support frame 30 are a vacuum blower 46 and a silencer 47 for the blower.

Ducting 48 provides communication of the vacuum between blower 46 and a vacuum port 49 in the centre of the top or upper face of the suction box, thereby providing a vacuum source to the suction box. A valve (not shown) associated with the blower allows the vacuum to be switched on and off under the control of an operator of the apparatus (usually the driver of the forklift truck). The upper face of the suction box also includes a remotely controlled vent valve 52 to allow the operator to quickly release a carried layer. The lower face of the suction box is a perforated plate comprising a grid of perforations which pass through the thickness of the plate and open onto the exterior surface thereby forming a suction surface 54 to allow a layer of goods to be held against and supported by the suction box. A similar construction is shown in US 2011/0121590, for example. The perforations and the spaces between them are sized to allow sufficient throughput of air and typically so that at least one and preferably several perforations will be closed off by one package or case of goods when the layer is covered by the suction box thereby ensuring that each package or case in the layer is lifted. If the perforations are too large or too far apart then there is a risk that some packages may not be lifted. The perforations can be any shape but will typically be circular. An exemplary size for each perforation is a cross-sectional area at the suction surface in the range of from 20 to 75 mm². The cross-section of the perforations through the thickness of the perforated plate need not be uniform; they could, for instance, flare out to the inside of the vacuum box.

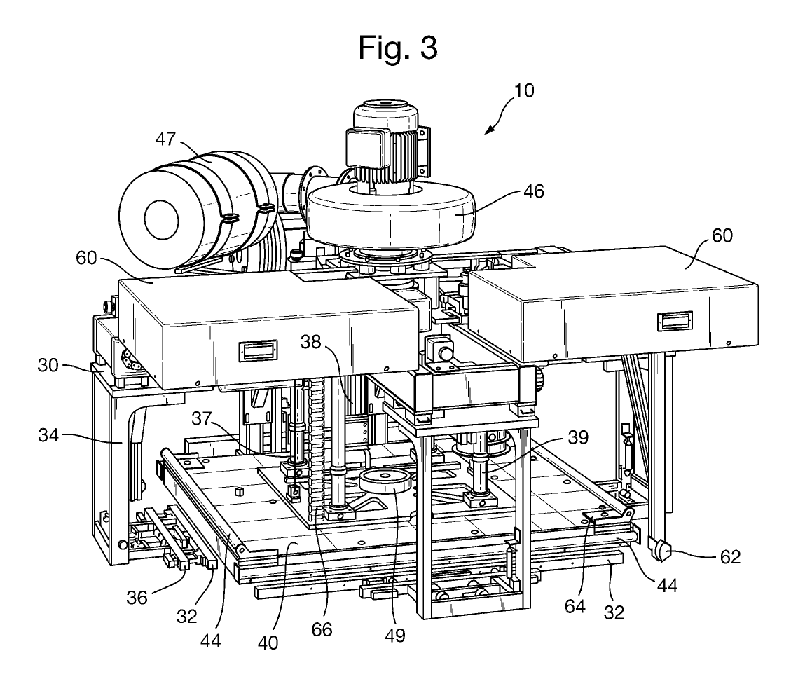

The apparatus is shown in more detail FIG. 3. This view shows control boxes 60 which house control circuitry for various motors, sensors and cameras and which communicate with the driver's control panel. The control circuitry also includes a proportionate, integrative and differential (PID) control loop for regulating the vacuum. The use of a PID loop allows for more efficient vacuum control and reduces the load on the forklift truck power supply. The driver of the truck can set the desired vacuum pressure in accordance with a pre-assigned vacuum pressure for lifting a layer of goods of known weight and the PID loop then maintains the desired vacuum pressure within a range of tolerance. A further aspect of the invention relates to the use of a PID loop for regulating the vacuum pressure of a vacuum lifting apparatus, especially one mounted on a forklift truck. Typical vacuum pressures required are from 1 to 3 kPa (10 to 30 mbar). A vacuum pressure of 2 kPa applied over an area of 1200 mm×1000 mm (a layer designed to fit a standard UK pallet size) will support a theoretical load of ˜245 kg, corresponding to an actual lift load of ˜120 kg when a safety factor of ˜2 is allowed for. A Euro-pallet sized area of 1200 mm×800 mm will support a 20% lower weight load for the same vacuum pressure but the range is of the same order of magnitude.

Attached to the support frame 30 are clamps comprising gantries 34 which each support clamping bar holders 36 and clamping bars 32. In this embodiment there are four clamps disposed outwardly of each of the four sides of the suction box so that the clamping bars are disposed to be pressed against each of the four faces of the skirt. Depending upon the structure of the skirt and the clamps there could be fewer clamps or more clamps. The function of the clamps is to position the skirt sufficiently close to a layer of goods being picked up so that, when the vacuum is switched on, the skirt is quickly sucked against the sides of the layer stopping further air leaking through its sides and allowing a sufficient vacuum pressure to be developed on the layer to allow it to be picked up by the suction box. Preferably the clamps hold the skirt in touching relationship with the layer before the vacuum is switched on and it is helpful in this regard if the clamping bars are sized to extend along a substantial portion, say 50% or more of the length of the layer edges. Each clamp gantry 34 is capable of a limited range of motor driven translation relative to the support plane in an x or y direction to allow the clamping bars to be moved towards or away from suction box 40 which, in this figure, is shown retracted onto skirt rollers 44. For clarity, in this figure the clamping bars are not shown connected to skirt 42 but in practice they are connected to its lower edge, by bolts or hooks for example, so that as the clamps move in the x or y direction they move the skirt towards or way from the layer of goods and, as the suction box moves upwards relative to the clamps the skirt is unwound from its rollers. Clamping bar holders 36 are pivotally mounted on clamp gantries but spring biased to be in the position shown whereby the holders extend horizontally away from the base of the gantries. The pivot mountings help prevent damage to the clamps if they are accidentally touched down onto e.g., a layer of goods. If that happens then the clamping bar holder pivots upwards and a tilt sensor signals an alarm to the cab driver. The tilt sensor can also be used to monitor when a carried layer is deposited onto a layer below or other deposition point such as an empty pallet.

As previously indicated, the suction box 40 is suspended from the support frame 30 by balancing cables 37 and a belt 38 and can translate vertically relative to the frame. In this embodiment there are two balancing cables 37, each fed from a spring wound spool, though only one cable is visible in the figure. Four guidance rods 39 are bolted to the suction box at their lower ends and at their upper ends pass through openings in the support frame. The guidance rods, which can be damped, provide further stability for the suction box. Fixed collars at the top of the guidance rods can prevent the rods being pulled out the frame in the event of failure of the balancing cables and belt. The function of belt 38, which is also wound from a sprung spool but is capable of supporting a much greater weight than the cables, is to hold the suction box at a set height when it is carrying a layer of goods. To fulfil this purpose the belt is coupled to a brake, operated by the driver, which prevents further unspooling of the belt as the layer is lifted.

To allow a driver of a forklift to accurately position the suction box relative to a layer, or to position a carried layer relative to a deposition point, the apparatus is preferably provided with cameras which send a video feed to a display screen in the driver's cab. In the embodiment shown there are four cameras which allow the driver to adjust the x/y positioning of the layer. Camera 62, and a similar camera at the diagonally opposite corner, is used to monitor the position of a carried layer relative to a deposition point, such as the top layer of a multi-layer pallet which is being built up. Camera cover 64 and its diagonally opposite counterpart conceal further cameras 62′ which look directly down from the corners of the suction box and assist in positioning of the suction box relative to a layer of goods which is about to be picked up. Cable chain 66 provides a feed to and from these cameras and other electrical sensors mounted to the suction box. Further cameras, not visible in this view, monitor the degree of vertical separation (z-separation) of the suction box from a layer of goods or of the bottom of a carried layer of goods from another layer below it.

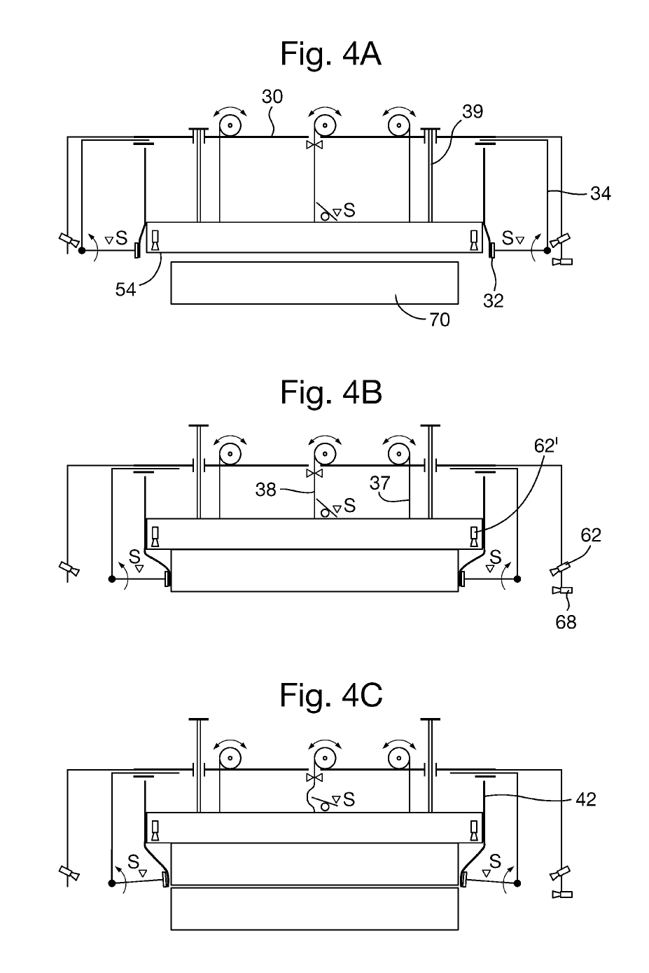

The operation of the apparatus will now be described in more detail with reference to schematic FIGS. 4A, 4B and 4C. In these figures S denotes a sensor.

FIG. 4A shows a suction box positioned over a layer of goods 70 to be picked up. At this point the suction box is in its fully descended position relative to the support frame 30 and the whole apparatus is moved up or down by the mast of the forklift truck. Balancing cables 37 support the weight of the suction box. The driver can use cameras 62 and 62′ to help him position the suction box accurately over the layer. A sensor coupled to the belt 38 monitors tension in the belt. As shown in FIG. 4B, once the suction box touches down on the top of the layer its weight is supported by the layer and, as the frame continues to move down, guidance rods slide upwards though frame 30. At the same time the vertical movement of the frame with its clamping bars 32 relative to the suction box unwinds more skirt 42 from its rollers 44 so that the skirt overlaps layer 70. The operator can then move the clamps inwards so that clamping bars 32 press the skirt against the side of the layer of goods. The force with which bars 32 are pressed against the layer is not high, just enough to hold the skirt snugly against the side of layer 70. The clamping bars 32 are sprung mounted within clamping bar holders 36 and sensors monitor the applied force. Once the skirt is in contact with the layer of goods then the driver can switch on the vacuum. This pulls the skirt securely around the layer and allows the layer to be lifted. To perform the lifting operation the driver applies the brake to the belt and lifts the whole apparatus using the forklift mast. Air pressure holds the layer of goods against suction face 54. Once the layer has been lifted, which the driver can monitor with z-separation cameras 68, the driver can safely drive the forklift truck away, carrying the layer with it.

To deposit the layer elsewhere the driver moves the forklift to the desired deposition point, and positions the layer over it, using the cameras to assist him Once the layer is properly positioned the driver can lower the apparatus with the forklift truck mast. As the layer touches down, since the belt still has the brake applied to it and cannot be wound back onto its spool, the belt becomes slack. This is detected by the belt sensor and a signal is sent to the driver. Likewise, tilt sensor on the clamp holders can also detect and signal the touchdown of the layer. The driver then opens the vent valve to release the vacuum and retracts the clamp so that the driver can then lift the apparatus away from the suction box and drive the forklift away.

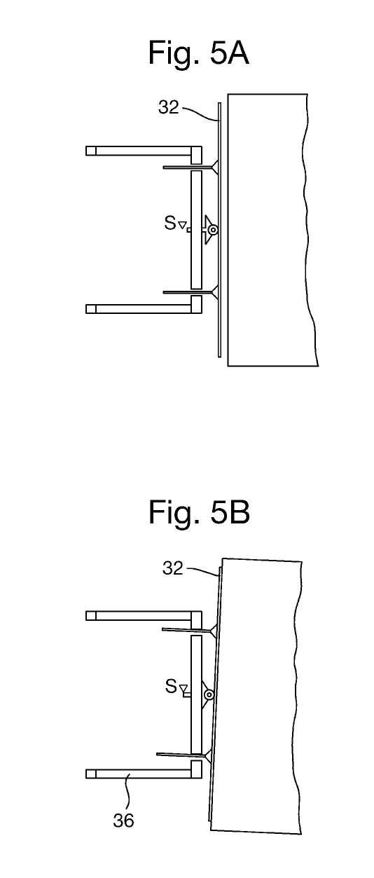

Pivoting of the clamping bars will now be explained by reference to FIGS. 5A and 5B. ‘S’ denotes a sensor which monitors the force applied to layer of goods 70 by the bar. The sensor enables automatic feedback control to the operation of the clamp. Advancement of each of the four clamps is under independent motorised control, as each of them may have a different distance to travel before making contact with the layer sides, so it is desirable to have the sensor automatically cut off the motor when the force applied to the goods (or intervening skirt) reaches a threshold level, thereby avoiding crush damage to the goods, wasting power or not pressing the skirt adequately against the layer. This avoids the need for the driver to position each clamp separately.

In the preferred embodiment, the clamping bars 32 can pivot about a vertical axis relative to the clamping bar holders 36. This feature enables a forklift truck driver to more rapidly position the suction box over a layer of goods and successfully lift it without damage to the goods or the apparatus and without undue energy usage. A skilled forklift truck driver who is experienced in use of the apparatus according to the invention will be able to approach a layer so that the clamping bars to each side of the suction box are parallel to the sides of the layer, as shown in FIG. 5A. This will ensure that when the clamping bars are extended from their holders to press the skirt against the layer they will each make even contact along their entire length. If, however, through inexperience or oversight, the driver has approached the layer obliquely, the clamping bars will end up at an angle to the sides of the layer and the bar will only touch at one end. If the bars are at a fixed orientation relative to the clamping bar holders then this may result in the skirt not being pressed against the layer properly, making it difficult to achieve a vacuum sufficient for lifting and requiring the driver to reposition the suction box by lifting it off the layer and approach the layer again from a different angle, resulting in wasted time and power. Alternatively, particularly if the friction between the bottom of the layer and it support layer or pallet is sufficiently low then the driver might be tempted to use the bars to nudge the layer into an altered position matching that of the suction truck. His ability to do this is limited by the pressure which can be applied to the clamping bars, which is under sensor control to avoid crush damage to the goods. In the case of a low moving force he might ultimately be successful by attempting several nudges but this will still result in wasted time and energy. The solution is to allow clamping bars 32 to pivot about a vertical axis relative to holders 36 as shown in FIG. 5B such that even if the first approach has been oblique to the layer the clamping bars can swivel to conform to the sides of the layer allowing the layer to be lifted without repositioning either the truck or the layer, thus enabling a faster, more efficient operation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Apparatus for mounting on a forklift truck for handling layers of goods, the apparatus comprising:
a) a support frame;
b) a suction box, suspended from the support frame, comprising:
i) a suction surface formed by a lower face of the suction box for placement against an upper surface of a layer of goods; and
ii) a skirt, depending from the suction box, having a generally rectangular horizontal section and four vertically disposed, laterally displaceable faces, for movement against the sides of a layer of packaged goods, thereby reducing air ingress through sides of the layer when a vacuum is applied through the suction surface,
c) a vacuum source connected to the suction box, for applying a vacuum to the suction surface in order to hold the layer of goods against the suction surface when the vacuum is applied;
d) at least one clamp attached to the support frame for positioning the skirt against the layer;
e) at least one valve for controlling the application of the vacuum to the suction surface; and
f) a fixture for mounting the support frame to a forklift truck.

2. Apparatus according to claim 1 wherein the vacuum source comprises a vacuum blower mounted on the suction box.

3. Apparatus according to claim 1 wherein the suction surface forms part of a suction plate comprising a plurality of perforations passing through the plate and opening onto the suction surface.

4. Apparatus according to claim 3 wherein the perforations in the suction plate have a cross-sectional area at the suction surface in the range from 20 to 75 mm².

5. Apparatus according to claim 1 wherein the skirt is segmented between its faces.

6. Apparatus according to claim 1 wherein the at least one clamp comprises a clamping bar.

7. Apparatus according to claim 1 wherein the clamp comprises a sensor to detect an application force of the clamping bar against the skirt.

8. Apparatus according to claim 6 wherein the clamping bar can pivot about a vertical axis.

9. Apparatus according to claim 1 further comprising at least one camera to assist a driver of the truck in positioning the suction box against the layer by horizontal movement.

10. Apparatus according to claim 9 further comprising at least one camera to assist a driver of the truck in positioning the suction box against the layer by vertical movement.

11. Apparatus according to claim 1, further comprising a proportionate, integrative and differential control loop for regulating the applied vacuum.

12. A forklift truck with the apparatus according to claim 1 fixed to it.

13. A method of lifting a layer of packaged goods having an upper surface and four sides, the method comprising the steps of:
a) providing a forklift truck adapted with apparatus comprising:
i) a support frame fixed to a mast of the forklift truck;
ii) a suction box, suspended from the support frame, comprising:
i.a suction surface formed by a lower face of the suction box for placement against an upper surface of a layer of goods; and
ii.a skirt, depending from the suction box, having a generally rectangular horizontal section and four vertically disposed, laterally displaceable faces, for movement against the sides of a layer of packaged goods, thereby reducing air ingress through sides of the layer when a vacuum is applied through the suction surface,
iii) a vacuum source connected to the suction box, for applying a vacuum to the suction surface in order to hold the layer of goods against the suction surface when the vacuum is applied;
iv) at least one clamp attached to the support frame for positioning the skirt against the layer;
v) at least one valve for controlling the application of the vacuum to the suction surface; and
vi) a fixture for mounting the support frame to a forklift truck
b) maneuvering the forklift truck until the suction box overlies the layer;
c) lowering the apparatus until the suction surface contacts the upper surface of the layer and the at least one clamp and skirt are disposed outwardly of the sides of the layer;
d) moving the at least one clamp to press the skirt faces against the sides of the layer;
e) applying sufficient vacuum through the suction surface to lift the layer when the suction box is lifted; and
f) lifting the suction box, thereby lifting the layer.

14. A method according to claim 13 wherein video cameras mounted on the apparatus are used to convey visual information to a driver of the forklift truck regarding the positioning of the suction box relative to the layer.

15. A method according to claim 13 wherein the suction box is suspended from the support frame by at least one cable or belt and locking the cable or belt at a fixed length allows the suction box to be lifted by the frame when the frame is lifted by the forklift truck.
